(19) United States
(12) Patent Application Publication
(10) Pub. No.: US 2026/0145815 A1
(43) Pub. Date: May 28, 2026

(54) MODULAR SATELLITE STRUCTURE FOR SATELLITE

(71) Applicant: K2 Space Corporation, Torrance, CA (US)

(72) Inventors: Neeldev KUNJUR, Torrance, CA (US); Drew MILLER, Torrance, CA (US); Matthew ALES, Torrance, CA (US)

(73) Assignee: K2 Space Corporation, Torrance, CA (US)

(21) Appl. No.: 19/435,358

(22) Filed: Dec. 29, 2025

Related U.S. Application Data
(63) Continuation of application No. PCT/US24/36182, filed on Jun. 28, 2024.
(60) Provisional application No. 63/524,004, filed on Jun. 29, 2023.

(51) Int. Cl. B64G 1/22; B64G 1/10; B64G 1/64

(52) U.S. Cl. CPC B64G 1/223; B64G 1/10; B64G 1/643; B64G 1/6455

(57) ABSTRACT

A frame for a satellite is provided. The frame includes a body and posts that are constructed of aluminum. The body can receive spacecraft components therein. The posts extend from the body and are operable to releasably couple with posts from another frame for another satellite and/or with a payload adaptor fitting.

### CROSS-REFERENCE TO RELATED APPLICATION

This application is a continuation of International Patent Application PCT/US24/036182 filed Jun. 28, 2024, which claims the benefit of U.S. Provisional Patent Application No. 63/524,004, filed in the U.S. Patent and Trademark Office on Jun. 29, 2023, each of which is incorporated herein by reference in its entirety for all purposes.

### FIELD

The present disclosure relates generally to satellite structures for satellites. In at least one example, the present disclosure relates to a primary satellite structure having a frame in which multiple satellites can be stacked within a launch vehicle.

### BACKGROUND

Conventional primary structures for large satellites have focused on mass optimized designs and, as a result, they are manufactured using composite panels with a central cylinder for translating static and dynamic loads from the launch vehicle to the spacecraft. This added manufacturing complexity increases costs and lead-times in addition to creating significant volume constraints for the spacecraft systems and tanks.

### BRIEF DESCRIPTION OF THE DRAWINGS

Implementations of the present technology will now be described, by way of example only, with reference to the attached figures, wherein:

FIGS. 1A-1C illustrate a primary structure in a stacked configuration that is operable to be received in a launch vehicle;

FIGS. 2A-2B illustrate the primary structure in an unstacked configuration;

FIG. 3 illustrates a modal survey of the primary structure; and

FIG. 4 illustrates a payload adaptor fitting.

### SUMMARY

Aspects of the present disclosure include a frame for a satellite. The frame includes a body and one or more posts extending from the body. The body can receive one or more spacecraft components. The one or more posts can releasably couple to another one or more posts of another frame for another satellite and/or with a payload adaptor fitting. The body and the one or more posts are made of aluminum.

In various possible examples, the body and the one or more posts being made of aluminum can conduct and/or radiate at least 7 kilowatts of dissipated payload heat.

In various possible examples, the body includes a top panel and a bottom panel.

In various possible examples, the one or more posts include a separable mechanical interface that can releasably couple with another frame. In some examples, the separable mechanical interface includes a joint that can be separated upon electrical activation of a pyrotechnic device.

In various possible examples, the frame and the another frame can be disposed within a launch vehicle when the one or more posts are releasably coupled with the another frame.

Aspects of the present disclosure include a satellite that includes one or more spacecraft components and a frame. The frame includes a body and one or more posts extending from the body. The body can receive one or more spacecraft components. The one or more posts can releasably couple to another one or more posts of another frame for another satellite and/or with a payload adaptor fitting. The frame is made of aluminum.

In various possible examples, the frame being made of aluminum can conduct and/or radiate at least 7 kilowatts of dissipated payload heat.

In various possible examples, the body includes a top panel and a bottom panel.

In various possible examples, the one or more posts include a separable mechanical interface that can releasably couple with another frame. In some examples, the separable mechanical interface includes a joint that can be separated upon electrical activation of a pyrotechnic device.

In various possible examples, the one or more spacecraft components includes at least one of: a payload, one or more solar arrays, one or more propellant tanks, and/or one or more thruster modules.

Aspects of the present disclosure include a launch vehicle. The launch vehicle includes a payload adaptor fitting and multiple satellites releasably stacked on one another. The satellites can be received on the payload adaptor fitting. Each of the satellites includes one or more spacecraft components and a frame. The frame includes a body and one or more posts. The body can receive the one or more spacecraft components. The one or more posts can separably couple with another one or more posts of another satellite of the multiple satellites and/or with the payload adaptor fitting. The frame is made of aluminum.

In various possible examples, frame being made of aluminum can conduct and/or radiate at least 7 kilowatts of dissipated payload heat.

In various possible examples, the body includes a top panel and a bottom panel.

In various possible examples, the one or more posts include a separable mechanical interface that can releasably couple with the frame of another satellite of the multiple satellites. In some examples, the separable mechanical interface includes a joint that can be separated upon electrical activation of a pyrotechnic device.

In various possible examples, the one or more spacecraft components includes at least one of: a payload, one or more solar arrays, one or more propellant tanks, and/or one or more thruster modules.

In various possible examples, the launch vehicle includes a deployment mechanism. The deployment mechanism causes the multiple satellites to fully separate and be deployed from the launch vehicle. In some examples, the deployment mechanism is operable to fully separate and deploy the multiple satellites by compressed springs and/or a maneuver of the launch vehicle.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Provided herein is a primary structure (also referred to as a satellite primary structure) that includes a frame to support a satellite within a launch vehicle. Multiple frames, each supporting a corresponding payload, can be stacked together within the launch vehicle. In other words, in an unstacked configuration, a single frame of the primary structure can support a single satellite. In a stacked configuration, multiple frames that are stacked together can each support one or more satellites. The primary structure is configured to optimize the stacking of high-mass satellites while maintaining significant thermal dissipation capabilities. For both a single frame and for multiple frames stacked together, the primary structure provides a structural load path between the payload and/or spacecraft systems and the launch vehicle. Additionally, the primary structure can sufficiently dissipate payload heat when offloaded from the launch vehicle. The frame is constructed of aluminum such that it provides both stiffness (e.g., rigidity) and thermal conductivity.

The satellite primary structure disclosed herein provides high thermal conductivity, high stiffness, and configuration modularity to support both stacked and unstacked payloads within a launch vehicle fairing. The structure utilizes a high-mass aluminum construction to provide the high thermal conductivity required to conduct and radiate more than 7 kilowatts (kW) of dissipated payload heat. The aluminum structural design provides inherently high stiffness allowing for significant margin against launch vehicle fundamental frequency limits even with high mass payloads. In some examples, the same structural design can be used to host high volume payloads in a single-manifest configuration within a launch vehicle but can also support low-volume payloads in a stackable architecture that supports launching a number of satellites, for example up to 12 satellites, within a Falcon 9 class launch vehicle fairing. The structural design eliminates the need for a central cylinder, significantly increasing the usable volume within the spacecraft for spacecraft systems.

The primary structure disclosed herein may provide significant benefits over conventional systems. In at least one example, the primary structure disclosed herein provides a single design configuration (e.g., modular) that can be used in both stackable or unstacked mission designs, which minimizes Non-Recurring Engineering (NRE). On the other hand, conventional primary structure designs are suitable for either stacking or not stacking (rather than both), which limits the missions that can be flown with a single structural design.

Additionally, the primary structure disclosed herein provides a streamlined design that provides both structural stiffness and high thermal conductivity without requiring additional, non-structural components to provide these functions. On the other hand, conventional systems are a more cumbersome design that requires additional components to provide the necessary stiffness and thermal conductivity, including expensive and failure-prone heat pipes.

Also, the primary structure disclosed herein utilizes low-cost materials that are easily procured and manufactured. The primary structure involves a highly manufacturable architecture that can be rapidly assembled. On the other hand, conventional systems utilize high-cost materials with exotic manufacturing processes. Further, conventional systems involve complex integration, which leads to long production times.

Conventional primary structures for large satellites are focused on mass optimized designs. As a result, conventional primary structures are commonly manufactured using composite panels with a central cylinder to translate static and dynamic loads from the launch vehicle to the spacecraft. Although the designs of these conventional primary structures may be mass optimal, the designs result in significant tradeoffs. For example, conventional systems require additional conductive elements for conducting high power dissipative payload heat from the payload to the radiator panels. Also, conventional systems have high cost and lead-times as a result of the manufacturing complexity associated with composite structures. Moreover, conventional systems impose significant volume constraints and spacecraft systems and tanks due to the central cylindrical features. Conventional systems have significant challenges in stacking and also limitations in stacked satellite density due to the need to translate the stacked heat load through central cylinders.

The presently disclosed primary structures address many shortcomings of conventional primary structures. For example, in some examples in the primary structure disclosed herein, all components are manufactured from heavier, but highly conductive and low-cost aluminum material to provide thermal conduction paths without the need to add significantly more components to provide heat conduction between the payload and the thermal radiators. In some examples, the satellite and payload loads are reacted directly out to four posts—without the need for a central cylinder—which provides an interface to the launch vehicle through an adapter plate (e.g., a payload adapter fitting) as well as support for satellites stacked on top of each other. In some examples the structural stiffness of the satellite can be readily tuned by varying the thickness of the aluminum panels without the need for additional stiffening sub-structure.

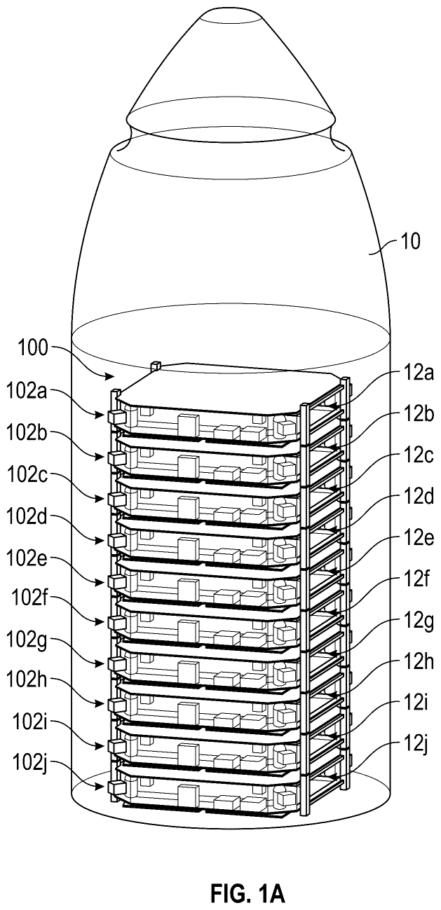

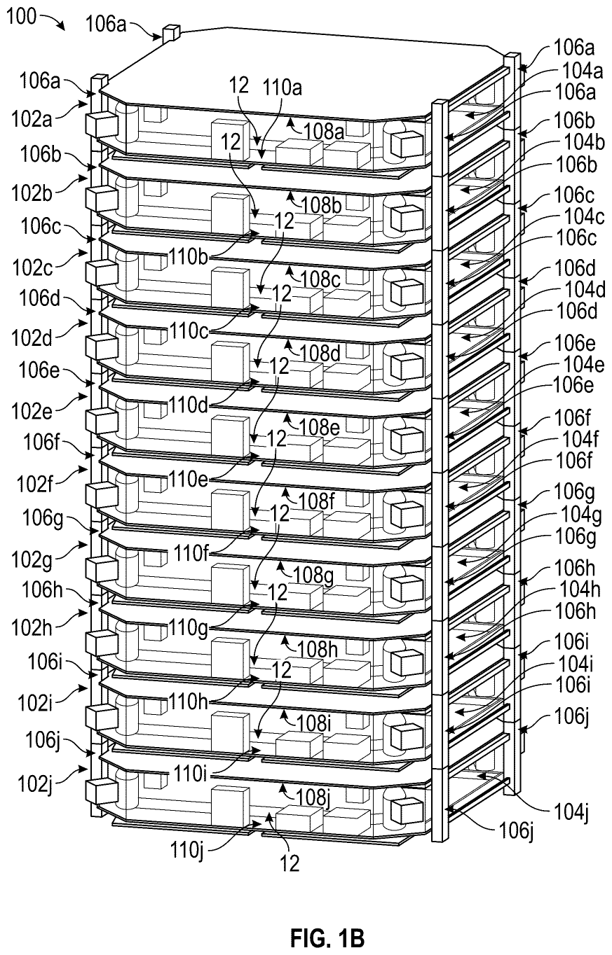

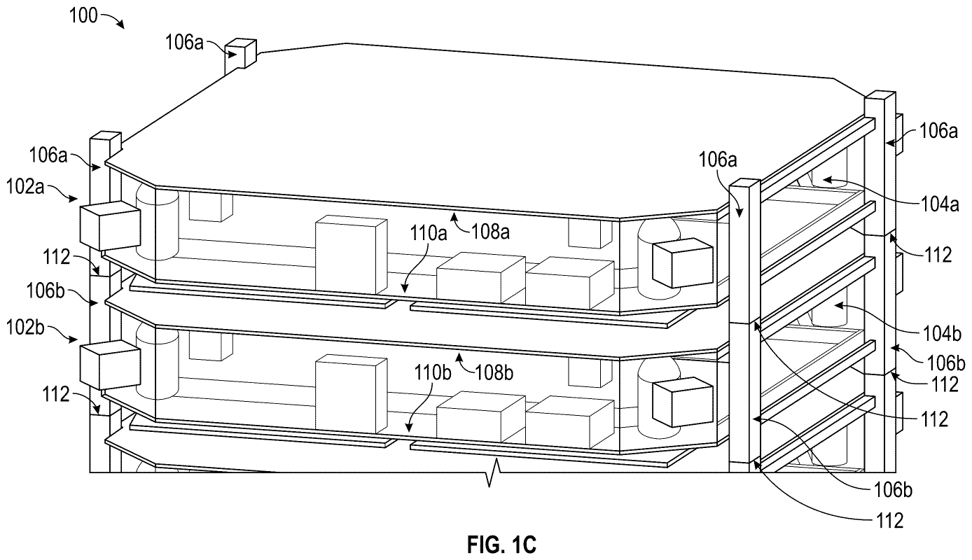

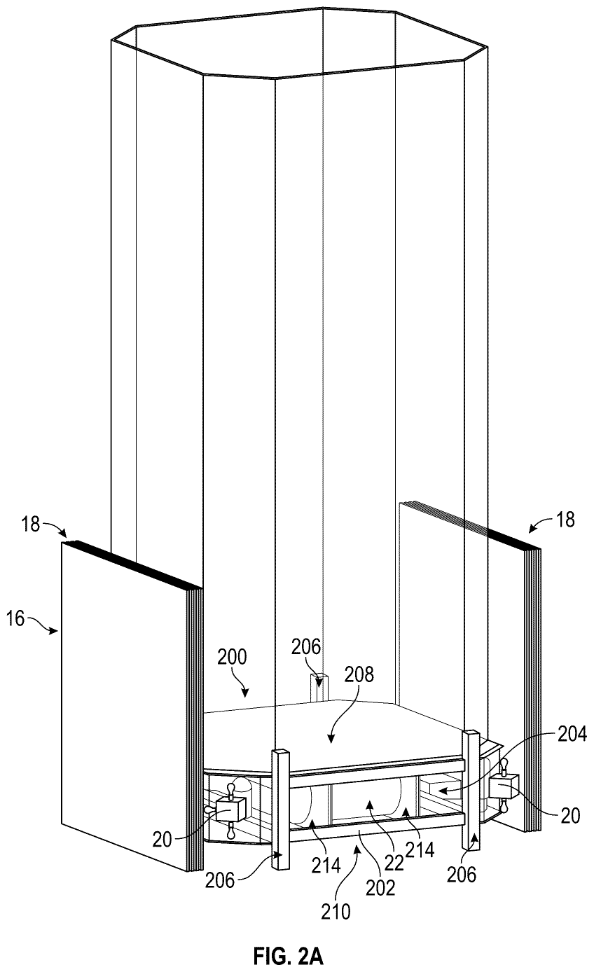

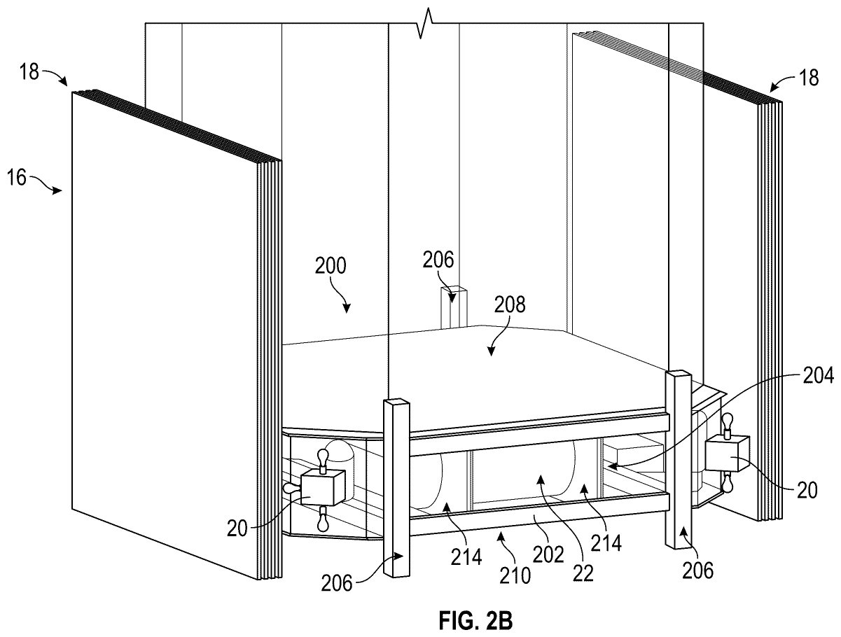

FIGS. 1A-1C illustrate a primary structure 100 (also referred to as a satellite primary structure). The primary structure 100 provides a frame for a payload 12, such as a spacecraft 16 (e.g., satellite) as illustrated for example in FIGS. 2A-2B, so that multiple payloads 12 can be stacked together within a launch vehicle 10 (also referred to as a launch vehicle fairing). Stacked payloads 12 can be subsequently separated and then offloaded from the launch vehicle 10. When the payload 12 is offloaded from the launch vehicle 10, the primary structure 100 dissipates heat. The primary structure 100 can be removably coupled to a launch vehicle 10 (e.g., launch vehicle), as illustrated for example in FIG. 1A, such that the primary structure 100 provides a structural load path between the payload 12 and the launch vehicle 10.

The primary structure 100 includes one or more frames 102 (e.g., frames 102a, 102b, 102c, 102d, 102e, 102f, 102g, 102h, 102i, 102j) that can be removably coupled (e.g., stacked) together in a stacked configuration, as illustrated for example in FIGS. 1A-1C. The primary structure 100 includes at least one frame 102, which can be stacked together with other frames 102. The primary structure 100 can be modular, such that frames 102 can be added to or subtracted from the primary structure 100. In some examples, additional frames 102 can be added or removably coupled to the primary structure 100. In a stacked configuration, multiple frames 102 can each support a corresponding payload 12 and can be stacked together within the launch vehicle 10. In some examples, one or more frames 102 within the primary structure 100 can be subtracted or decoupled from the primary structure 100. For example, the primary structure 100 can include only one frame 102 in an unstacked configuration (such as the frame 202 as illustrated in FIGS. 2A-2B). In an unstacked configuration, one frame 102 (e.g., frame 102a) can support a corresponding payload 12 (e.g., payload 12a). In at least one example, as illustrated in FIGS. 1A-1B, the primary structure 100 can include ten frames 102. In other examples, the primary structure 100 can include less than ten frames 102. In other examples, the primary structure 100 can include more than ten frames 102. In some examples, the primary structure 100 can include up to twelve frames 102.

Each frame 102 includes a body 104 (e.g., bodies 104a, 104b, 104c, 104d, 104e, 104f, 104g, 104h, 104i, 104j) and one or more posts 106 extending therefrom. Each body 104 can receive (e.g., support) a payload 12 (e.g., payloads 12a, 12b, 12c, 12d, 12e, 12f, 12g, 12h, 12i, 12j) therein. In some examples, the payload 12 can include a spacecraft 16 (e.g., a satellite) as illustrated for example in FIGS. 2A-2B, such that each body 104 can receive a satellite therein. In some examples, the primary structure 100 is a portion of the satellite (i.e., payload 12) that provides a structural load path between the payload 12 (e.g., spacecraft systems) and the launch vehicle 10.

In some examples, the frame 102 (e.g., body 104, posts 106) is at least partially constructed of aluminum. For example, the body 104 can at least partially be constructed of aluminum. Additionally or separately, the posts 106 can be at least partially constructed of aluminum. In at least one example, both the body 104 and the posts 106 are at least partially constructed of aluminum. In some examples, greater than 50% of each of the frame 102, the body 104, and/or the posts 106 can be constructed of aluminum. In some examples, greater than 75% of each of the frame 102, the body 104, and/or the posts 106 can be constructed of aluminum. In some examples, greater than 90% of each of the frame 102, the body 104, and/or the posts 106 can be constructed of aluminum. In some examples, each of the frame 102, the body 104, and/or the posts 106 can be fully constructed of aluminum. The aluminum allows the primary structure 100 to dissipate heat when the payload 12 is offloaded from the launch vehicle 10. In some examples, the high-mass aluminum frame 102 can provide the high thermal conductivity to conduct and radiate more than 7 kilowatts (kW) of dissipated heat from the payload 12.

Continuing with FIGS. 1A-1C, each of one or more posts 106 (e.g., posts 106a, 106b, 106c, 106d, 106e, 106f, 106g, 106h, 106i, 106j) extends from each body 104. In some examples, as illustrated for example in FIGS. 1A-1B, each frame 102 includes four posts 106. In other examples, each frame 102 includes less than four posts 106. In other examples, each frame 102 includes more than four posts 106. In some examples, a longitudinal axis of each post 106 (e.g., 106a) is generally perpendicular to a plane of each respective body 104 (e.g., body 104a). For example, when removably coupled to a launch vehicle 10 when the launch vehicle 10 is in an upright (e.g., vertical) position, the plane of each body 104 can be generally horizontal in orientation and the longitudinal axis of each post 106 can be generally vertical in orientation.

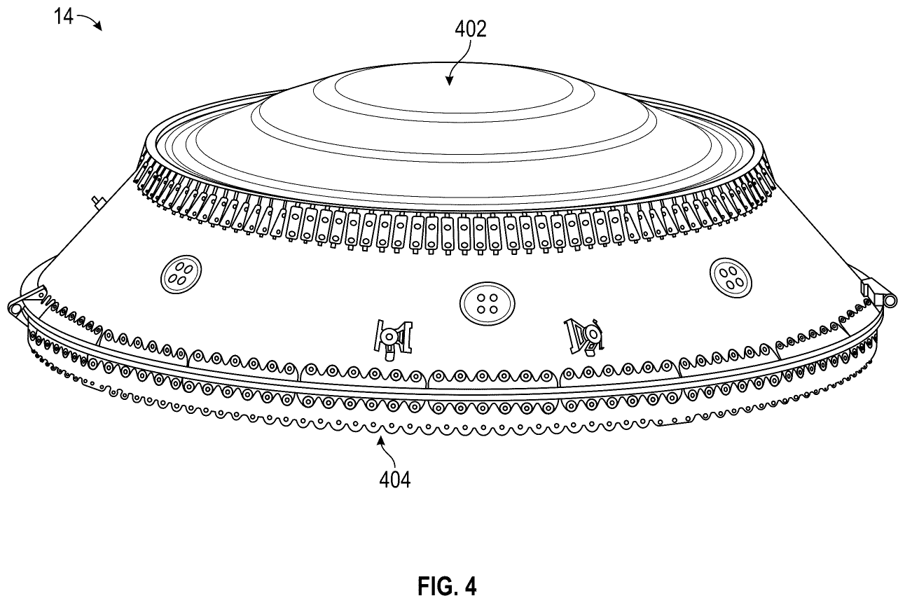

The posts 106 (e.g., post 106a) of each frame 102 (e.g., frame 102a) can be releasably coupled to another set of posts 106 (e.g., post 106b) of another frame 102 (e.g., frame 102b) and/or a payload adaptor fitting 14 (as illustrated for example in FIG. 4). In some examples, the posts 106 of each frame 102 are releasably coupled to another set of posts 106 of another frame 102 via a separable mechanical interface 112, as illustrated in FIG. 1C. For example, each separable mechanical interface 112 can be integrated into each post 106. In other examples, the separable mechanical interface 112 can be integrated into a hold-down band (not illustrated in the figures) on a stack of frames 102. Each separable mechanical interface 112 can define a joint that can be separated by electrical and/or mechanical activation, such as with a pyrotechnic device. The primary structure 100 may include a controller that can be in communication with a controller for the launch vehicle 10. The launch vehicle 10 may determine that a desired orbit has been achieved and send a signal to the controller for the primary structure 100, which then activates the separation mechanism to separate the payloads 12. After the separable mechanical interface 112 is separated, the stack of satellites (i.e., payload 12) are separated such that the satellites 12 can be deployed by the use of positive force applied to each satellite 12 in the stack. In some examples, the positive force can be applied with compressed springs and/or with maneuver of the launch vehicle 10 to provide positive energy such that the stack of satellites can separate.

As illustrated in FIGS. 1A-1B, a first set of posts 106a can be releasably coupled to a second set of posts 106b. The second set of posts 106b can be releasably coupled to a third set of posts 106c. The third set of posts 106c can be releasably coupled to a fourth set of posts 106d. The fourth set of posts 106d can be releasably coupled to a fifth set of posts 106e. The fifth set of posts 106e can be releasably coupled to a sixth set of posts 106f. The sixth set of posts 106f can be releasably coupled to a seventh set of posts 106g. The seventh set of posts 106g can be releasably coupled to an eighth set of posts 106h. The eighth set of posts 106h can be releasably coupled to a ninth set of posts 106i. The ninth set of posts 106i can be releasably coupled to a tenth set of posts 106j. The tenth set of posts 106j (as illustrated in FIG. 1B) can be releasably coupled to the payload adaptor fitting 14 (as illustrated for example in FIG. 4).

Continuing with FIGS. 1A-1C, each frame 102 can include a top panel 108 (e.g., top panels 108a, 108b, 108c, 108d, 108e, 108f, 108g, 108h, 108i, 108j) and/or a bottom panel 110 (e.g., bottom panels 110a, 110b, 110c, 110d, 110e, 110f, 110g, 110h, 110i, 110j). In some examples, a plane of each top panel 108 (e.g., top panel 108a) is generally perpendicular to a longitudinal axis of each of the respective posts 106 (e.g., post 106a). Similarly, in some examples, a plane of each bottom panel 110 (e.g., bottom panel 110a) is generally perpendicular to a longitudinal axis of each of the respective posts 106 (e.g., post 106a). For example, when removably coupled to a launch vehicle 10 when the launch vehicle 10 is in an upright (e.g., vertical) position, the plane of each top panel 108 and the plane of each bottom panel 110 can be generally horizontal in orientation.

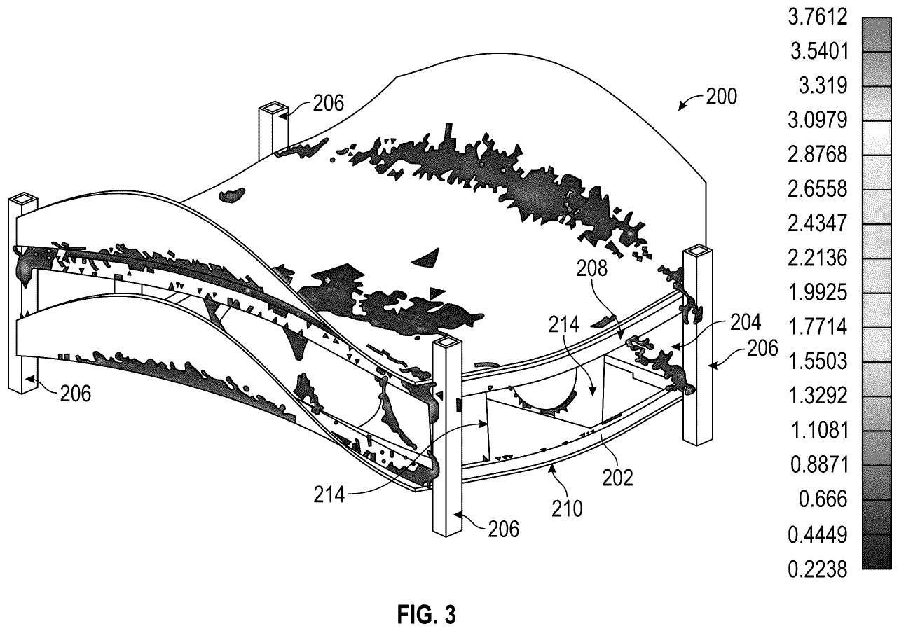

In some examples, for example as illustrated in FIG. 3, the top panel 108 and the bottom panel 110 can each have a curvature such that the lateral ends of the top panel 108 and the bottom panel 110 can extend upwards, forming a dip towards the center of the top panel 108 and the bottom panel 110.

In some examples, an extensive bounding analysis is performed on the primary structure 100 to identify thermal conductivity and thermal paths required to ensure a bounding payload 12 is kept within operational limits at all times during all possible missions. In some examples, the top panel 108 and the bottom panel 110 are tuned to achieve both a desired structural stiffness as well as the desired thermal conduction properties. For example, the thickness can be determined using combined structural and thermal analysis.

FIGS. 2A-2B illustrates a primary structure 200. As illustrated, the primary structure 200 includes one frame 202 in an unstacked configuration. However, the frame 202 is designed to be operable for a stacked configuration (as illustrated for example by the stacked frames 102 in FIGS. 1A-1C). The primary structure 200 can have one or more same or similar features as the primary structure 100 (as illustrated for example in FIGS. 1A-1C). Due to the same or similar features, the reference numbers and corresponding description provided above for various components, elements, portions, etc., of the primary structure 100 in FIGS. 1A-1C can be generally applied to the same or similar components, elements, portions, etc., provided for the primary structure 200 in FIGS. 2A-2B; however, the reference numbers in FIGS. 2A-2B are 200 series rather than 100 series.

In some examples, the frame 202 extends outside of the top panel 208 and bottom panel 210 to provide mounting points for stacked spacecraft 16 (e.g., stacked satellites). For example, when the spacecraft 16 are stacked, the spacecraft 16 can be mounted to the frame 202 that extends outside of the top panel 208 and bottom panel 210.

One or more plates 214 can extend between the top panel 208 and bottom panel 210 of each primary structure 200. In some examples, each plate 214 extends around one or more propellant tanks 22 such that each plate 214 inhibits movement (e.g., translation, rotation) of the propellant tanks 22. Each plate 214 can provide structural stiffening, thermal conductivity between the top panel 208 and bottom panel 210, and/or a combination thereof. In at least one example, each plate 214 can be at least partially constructed of aluminum. In some examples, greater than 50% of each plate 214 can be constructed of aluminum. In some examples, greater than 75% of each plate 214 can be constructed of aluminum. In some examples, greater than 90% of each plate 214 can be constructed of aluminum. In some examples, each plate 214 can be entirely constructed of aluminum. By being made of aluminum, the plates 214 can dissipate heat adequately while being structural strong to handle the mechanical and vibrational forces acting thereon during launch, flight, etc.

The payload illustrated in FIGS. 2A-2B includes a spacecraft 16 (e.g., satellite). One or more solar arrays 18 can be coupled to the spacecraft 16. In some examples, as illustrated for example in FIGS. 2A-2B, the solar arrays 18 can be coupled to the side of the spacecraft 16. In other examples, the solar arrays 18 can be coupled underneath the spacecraft 16. One or more thruster modules 20 can be coupled to the spacecraft 16 such that the thrust modules 20 can be used for attitude control of the spacecraft 16. In some examples, a thruster module 20 is installed on each corner of the spacecraft 16. One or more propellant tanks 22 can be coupled to the spacecraft 16. In some examples, the propellant tanks 22 are generally cylindrical in shape. Plates 214 can extend around the propellant tanks 22 to maintain the position of the propellant tanks 22.

FIG. 3 illustrates a modal survey of a primary structure. A modal survey is a Finite Element Analysis (FEA) that identifies the different bending modes of a structure as a function of natural frequencies. The modal survey illustrated in FIG. 3 was performed on a model of a primary structure, such as primary structure 100 (as illustrated for example in FIGS. 1A-1B) or primary structure 200 (as illustrated for example in FIGS. 2A-2B). The modal structure, as illustrated in FIG. 3, exaggerates the identified bending modes to illustrate what these bending modes look like. For example, the angle is simply showing a bending mode that the structure may exhibit when subject to a specific frequency of disturbance force.

FIG. 4 illustrates payload adapter fitting 14 (also referred to as a PAF). The payload adapter fitting 14 (as illustrated for example in FIG. 4) can be positioned below or underneath the primary structure 100 (as illustrated for example in FIGS. 1A-1C) or the primary structure 200 (as illustrated for example in FIGS. 2A-2B). In some examples, an adapter plate (not shown in the figures) is positioned or otherwise sits between the primary structure (e.g., primary structure 100, primary structure 200) and the payload adapter fitting 14. In this configuration, the adapter plate provides a load path (e.g., a mechanical interface between the primary load paths) between the primary structure 100, 200 (e.g., posts 106, 206) and the payload adapter fitting 14.

In some examples, the launch vehicle 10 (as illustrated for example in FIG. 1A) includes a payload adapter fitting 14. The payload adapter fitting 14 can receive the payload 12, such as spacecraft 16 (e.g., satellites) in a stacked configuration. In some examples, the payload 12 can be releasably stacked (e.g., releasably coupled) as previously discussed.

As illustrated in FIG. 4, the payload adapter fitting 14 can include a top surface 402 and a bottom surface 404 opposite the top surface 402. The top surface 402 can be adjacent to, proximate to, and/or abutting the payload 12 and/or the primary structure 100, 200. The top surface 402 can be configured to receive the payload 12 and/or the primary structure 100, 200. The bottom surface 404 can be received by the launch vehicle 10, for example a floor or a surface of the launch vehicle 10. In some examples, the bottom surface 404 can be coupled with the launch vehicle 10.

The payload adapter fitting 14 can be operable to be in communication with the launch vehicle 10. For example, the payload adapter fitting 14 can be operable to facilitate the separation of the payload(s) 12 received by the primary structure 100, 200 once the launch vehicle 10 has reached the intended orbit. The payload adapter fitting 14 can be operable to receive a signal from the launch vehicle 10 that the intended orbit has been reached and/or to release one or more payload(s) 12 from the primary structure 100, 200. The payload adapter fitting 14 can then communicate with the primary structure 100, 200 to release the payload(s) 12. The payload adapter fitting 14 can provide a stable and aligned base for the primary structure 100, 200 and/or the payload(s) 12 during the dynamic forces (e.g., vibrational and/or mechanical loads) of launch.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A frame for a satellite comprising:
a body operable to receive one or more spacecraft components; and
one or more posts extending from the body, the one or more posts operable to releasably couple with another one or more posts of another frame for another satellite and/or with a payload adaptor fitting,
wherein the body and the one or more posts are at least partially made of aluminum.

2. The frame of claim 1, wherein the body and the one or more posts being made of aluminum is operable to conduct and/or radiate at least 7 kilowatts of dissipated payload heat.

3. The frame of claim 1, wherein the one or more posts include a separable mechanical interface operable to releasably couple with the another frame.

4. The frame of claim 3, wherein the separable mechanical interface includes a joint that is operable to be separated upon electrical activation of a pyrotechnic device.

5. The frame of claim 1, wherein the frame and the another frame are operable to be disposed within a launch vehicle when the one or more posts are releasably coupled with the another frame.

6. The frame of claim 1, wherein greater than 50% of each of the body and the one or more posts are made of aluminum.

7. The frame of claim 1, wherein the entirety of each of the body and the one or more posts are made of aluminum.

8. A satellite comprising:
one or more spacecraft components; and
a frame including:
a body operable to receive the one or more spacecraft components; and
one or more posts extending from the body, the one or more posts operable to releasably couple with another one or more posts of another satellite and/or with a payload adaptor fitting,
wherein the frame is at least partially made of aluminum.

9. The satellite of claim 8, wherein the frame being made of aluminum is operable to conduct and/or radiate at least 7 kilowatts of dissipated payload heat.

10. The satellite of claim 8, wherein the one or more posts include a separable mechanical interface operable to releasably couple with the another frame.

11. The satellite of claim 10, wherein the separable mechanical interface includes a joint that is operable to be separated upon electrical activation of a pyrotechnic device.

13. The satellite of claim 8, wherein the one or more spacecraft components includes at least one of: a payload, one or more solar arrays, one or more propellant tanks, and/or one or more thruster modules.

14. The satellite of claim 8, wherein greater than 50% of each of the body and the one or more posts are made of aluminum.

15. A launch vehicle comprising:
a payload adaptor fitting;
a plurality of satellites releasably stacked on one another, the plurality of satellites operable to be received on the payload adaptor fitting, each of the plurality of satellites including:
one or more spacecraft components; and
a frame including:
a body operable to receive the one or more spacecraft components; and
one or more posts extending from the body, the one or more posts operable to separably couple with another one or more posts of another satellite of the plurality of satellites and/or with the payload adaptor fitting,
wherein the frame is at least partially made of aluminum.

16. The launch vehicle of claim 15, wherein the frame being made of aluminum is operable to conduct and/or radiate at least 7 kilowatts of dissipated payload heat.

17. The launch vehicle of claim 15, wherein the one or more posts include a separable mechanical interface operable to separably couple with the frame of the another satellite of the plurality of satellites.

18. The launch vehicle of claim 17, wherein the separable mechanical interface includes a joint that is operable to be separated upon electrical activation of a pyrotechnic device.

19. The launch vehicle of claim 15, further comprising a deployment mechanism; wherein the deployment mechanism causes the plurality of satellites to fully separate and be deployed from the launch vehicle.

20. The launch vehicle of claim 19, wherein the deployment mechanism is operable to fully separate and deploy the plurality of satellites by compressed springs and/or a maneuver of the launch vehicle.
